(19) United States
(12) Patent Application Publication
(10) Pub. No.: US 2025/0085031 A1
(43) Pub. Date: Mar. 13, 2025

(54) SUSTAINABLE SOLAR ENERGY CARRIER

(71) Applicant: Hamidreza ZARRINKAFSH, Tallinn (EE)

(72) Inventor: Hamidreza ZARRINKAFSH, Tallinn (EE)

(21) Appl. No.: 18/724,941

(22) PCT Filed: Dec. 27, 2021
(86) PCT No.: PCT/IB2021/062323

§ 371 Date: Jun. 27, 2024

(51) Int. Cl. F24V 30/00; A47J 36/30; B65D 81/34; F23Q 25/00; F28D 19/04

(52) U.S. Cl. CPC F24V 30/00; A47J 36/30; B65D 81/3476; F23Q 25/00; F28D 19/04

(57) ABSTRACT

A sustainable solar energy carrier that generates heat without emissioning any gas such as GHGs and can be recycled and recharged by solar energy. The energy carrier is completely environmental-friendly before and after usage and can be activated mechanically or electrically to generate a huge amount of heat in a closed space. It contains both fuel materials to release energy by burning them, and oxygen generator materials to provide the required oxygen. Furthermore, it contains heat production controller and heat consumption controller materials to be safe. The energy carrier may be occupied in a package as a thermal battery that can be removably placed within or removed from a self-heating product to heat a content such as food, beverage, clothes, food delivery bag, buildings, etc. The thermal battery is a single-use heater and can be brought back to the producer company to be recharged by solar energy after the usage.

### TECHNICAL FIELD

The utility model relates to a zero-emission heat generating fuel which may generate heat without emissioning any gas such as greenhouse gases and after usage may be recycled and recharged by solar heating. It generates a huge amount of energy for verity of applications, especially in a situation which is difficult to access any external sources of energy. The present disclosure particularly relates to a fuel that can heat anything that a human needs to be warmed up from a building or a house, to a camping tent, a clothes, or a food and beverage packaging, etc. The present disclosure more particularly relates to a portable pre-mixed fuel which can be activated by a mechanical or electrical activator and can be continued spontaneously to generate heat in an adjustable period of time in a closed or semi-closed space.

### BACKGROUND ART

Zero-emission fuels have been used for several applications that need a huge amount of energy in a short period of time such as welding in remote areas, water boilers, warmers, etc. These kind of fuels which generate energy without releasing any gas emissions are used in energy storages, electricity generation sectors, or motion in the mobility sector. They have also altered to be used in some special applications such as Self-Heating technology to warm up food and beverage for those are in travel, camping, daily commute from work to home, working in remote areas, or caught in critical situations due to, for example, floods, earthquakes, tornados, maneuvers or war.

In order to be used in a wide verity of applications, these fuels may be formulated to be flexible to be modified for a specific application. For example they should be small and light enough to be carried out by a human in a long time in mountains, safe enough, odorless and non-toxic for food and beverages, have long expiration date for energy storage applications, have short operation time or alternatively very long operation time, and being environmentally friendly.

These features became more important for utilizing the fuel in the packaging of foods and beverages which has a lucrative market and will be the next trend due to the people's lack of time to prepare foods in this modern era and the willingness of humans to have more convenient food and beverage packaging with an ability of heating the packaging content in a short time. The former self-heating technology was bulky, heavy, unsafe, and did not work in a cold weather. Moreover, since the reaction was soluble, a small amount of water mixed with a compound in a closed space, which caused two major problems. Firstly, the reaction boiled its water inside a closed space and the vapor did not have enough space, therefore many blasting of the former self-heating technology have been reported. Secondly, the water in the soluble reaction made several freezing problems in a cold weather when it was exactly the best time to sell this technology and the products did not work.

There are 2 major kinds of concept in the background of this technology, namely, soluble reactions, and solid-state reactions. The soluble reactions are divided to three main reactions. First, quicklime and water (e.g. EP1749465, U.S. Pat. Nos. 4,559,921, 4,793,323, and EP 828700773), which occupy approximately half of the package volume and does not work in winters. Second, oxidation-reduction reaction between an acid and an alkali (e.g. U.S. Pat. No. 5,935,486), which has numerous limitations such as high cost, unreliability, and the risk of explosion. Third, oxidation-reduction reaction between a metal and a metal oxide (e.g. U.S. Pat. No. 3,874,504), which has the aforementioned problems. All of the above patents have the same problem which is caused by the soluble reaction concept.

The solid-state reactions have been developed by many patents however, there is no any successful product with this technology in the market yet with a reasonable price. Although this technology does not have the challenges of using soluble reactions, there are many other challenges in formulating such a reaction to be safe and efficient. The reaction must not release any gas due to being in a closed space, it should have environmental-friendly characteristics before and after reaction, and must not be bulky, heavy, explosive, and expensive. Most of the registered patents in this technology used nanoparticles, therefore the cost of production dramatically increased and caused to be dangerous. Moreover, since the controlling Nano reactants require to add a large amount of a diluents or Nano clay material, the volume of the heater in the package have been considerably increased.

In addition to the mentioned challenges, the formulated solid-state reactions required a large amount of activation energy to be activated. Although this can protect the product to not be activated inadvertently, but the design of the activator was always a challenging part. Some of the former patents activated by a special matches or a lighter which produced fumes and odors and was very inconvenient for the user. Moreover, there was a hole through the wick or fuse which was a place for the leakage of the solid-state powder reactants. On the other hand, the storage of released byproducts was a challenge in the small space of packaging. The problems of these patents was not limited to this problems and the most important challenge of these products was the possibility of overheating and blasting which was controlled with such a complicated shot down mechanism that may not work in some challenging situations. Another issue that was associated with these products was the integration of heater and the packaging and changing the production line of a factory which was very costly and difficult. Thus, a need for a more sustainable, safe, unexpansive, effective and efficient self-heating technologies which may simply implement and integrate within a food and beverage packaging may require to rethink about a new approach for this lucrative technology.

### SUMMARY OF THE DISCLOSURE

The present summary, which discusses just an overview of the subject matter, does not intend to determine the scope of the claimed implementations or disclose key elements of the subject matter. The proper scope of the present disclosure may be ascertained from the claims set forth below in view of the detailed description and. The appropriate scope of the present disclosure can be determined from the claims mentioned below in view of the detailed descriptions and the drawings.

The present disclosure is directed to a zero-emission fuel which can be employed to warm up anything that a human needs to heat it and some applications will be introduced according to one or more exemplary embodiments. The fuel which is formulated and premixed can be positioned in a closed or semi-closed container and heat food or beverage packaging or a food delivery bag. The exemplary premixed fuel may include a group of substances which can be oxidized, a group of oxidizing substances, a group of materials which control the heat producing rate, and another group which control the heat consuming rate. These groups of substances which are named as a premixed fuel may be activated by an activator which may be mechanical or electrical depend on the required application.

The exemplary container which include the premixed fuel and activator can transfer heat to other things by conduction, convection, and radiation. An exemplary closed container which include the premixed fuel and activator may be placed in the food or beverage packaging or food delivery bags, or may be connected to the exterior part of them. To mention some examples, it may connect to a regular beverage cans or food packaging cans. The product may also be placed in a food delivery box to keep the food warm during the delivery process by food delivery couriers. It may also be placed inside a double layered smart thermos which can boil water to brew a fresh brewed coffee, tea, and herbal tea. Moreover, it may be place in a baby bottle to help mothers who are worried about feeding their baby out of home. They can to make an infant formula in a baby bottle or make it in the mentioned thermos and spill it to a baby bottle to feed their beloved children.

As it was mentioned, the exemplary premixed fuel has four main groups of substances which formulated to generate oxygen, burn with oxygen, control the heat producing rate, control the heat consuming rate. The substances which release oxygen may be sensitive to temperature and may decompose in a temperature between 100 to 300 Celsius degrees to produce oxygen. The substance that control the heat producing rate and the other group which control the consuming rate may be inert during the reaction and just avoid overheating phenomena. An exemplary container may include an activator inside or outside the container. An exemplary activator may include a chemical starter which is covered by a membrane and may be activated either mechanically or electrically. The mechanical activator may have a component like a rod which moves through the membrane and rapture the membrane in a predesigned way to expose the fuel and the chemical starter to each other. This exposure may trigger a spontaneous reaction which can be continued through the fuel and is self-sustained until the end of a predesigned path through the premixed fuel. A heat resistant adhesive tape is attached to the membrane which is designed to help the membrane to be raptured very precisely in a predesigned way in order to avoid hindering the exposure of the chemical starter with the premixed fuel. The electrical activator may include a soldering iron which is powered by a battery and may heat the chemical starter to combust it. The combustion heat can start a reaction through the premixed fuel in a predesigned path. The produced heat may warm up any kind of things that a human needs to be warmed up such as a food and beverage packaging, clothes, etc.

### BRIEF DESCRIPTION OF THE DRAWINGS

New features that are believed to characterize the current disclosure in terms of structure, organization, use, and the operation method, along with its goals and benefits, are better understood from the following drawings in which the current visualization is preferred and will now be shown as an example. It is clear that the drawings are for description and description only and are not intended as a definition of the limits of the present disclosure. The present disclosures are now explained, for example, with accompanying drawings in which:

FIG. 1 illustrates a heater system, consistent with some of the exemplary embodiments of the present disclosure;

FIG. 2A illustrates a perspective view of a heater system with a mechanical activator, consistent with some of the exemplary embodiments of the present disclosure;

FIG. 2B illustrates a sectional side view of a heater system with a mechanical activator in a passive state consistent with some of the exemplary embodiments of the present disclosure;

FIG. 2C illustrates a sectional side view of a heater system with a mechanical activator in an activated state, consistent with some of the exemplary embodiments of the present disclosure;

FIG. 2D illustrates a perspective view of a mechanical activator of a heater system in a passive state, consistent with some of the exemplary embodiments of the present disclosure;

FIG. 2E illustrates a perspective view of a mechanical activator of a heater system in an activated state, consistent with some of the exemplary embodiments of the present disclosure;

FIG. 2F illustrates a perspective view of a heater system with an electrical activator, consistent with some of the exemplary embodiments of the present disclosure;

FIG. 3 illustrates a perspective view of a thermal battery and it's packaging, consistent with some of the exemplary embodiments of the present disclosure;

FIG. 4A illustrates a sectional side view of an extinguisher system, consistent with some of the exemplary embodiments of the present disclosure;

FIG. 4B illustrates a perspective view and some sectional side view in different directions of the extinguisher system, consistent with some of the exemplary embodiments of the present disclosure;

FIG. 5A illustrates a sectional side view of an aluminum can heater in a passive state, consistent with some of the exemplary embodiments of the present disclosure;

FIG. 5B illustrates a sectional side view of an aluminum can heater in an activated state, consistent with some of the exemplary embodiments of the present disclosure;

FIG. 5C illustrates a sectional side view of a can heater in a passive state, consistent with some of the exemplary embodiments of the present disclosure;

FIG. 5D illustrates a sectional side view of a can heater in an activated state, consistent with some of the exemplary embodiments of the present disclosure;

FIG. 6A illustrates a sectional side view of a smart thermos heater with a mechanical activator in a passive state, consistent with some of the exemplary embodiments of the present disclosure;

FIG. 6B illustrates a sectional side view of a smart thermos heater with a mechanical activator in an activated state, consistent with some of the exemplary embodiments of the present disclosure;

FIG. 6C illustrates a sectional side view of a smart thermos heater with an electrical activator, consistent with some of the exemplary embodiments of the present disclosure;

FIG. 7A illustrates a sectional side view of a disposable cup heater with a mechanical activator in a passive state, consistent with some of the exemplary embodiments of the present disclosure;

FIG. 7B illustrates a sectional side view of a disposable cup heater with a mechanical activator in an activated state, consistent with some of the exemplary embodiments of the present disclosure;

FIG. 8A illustrates a sectional side view of a fresh-brewed coffee maker with a mechanical activator in a passive state, consistent with some of the exemplary embodiments of the present disclosure;

FIG. 8B illustrates a sectional side view of a fresh-brewed coffee maker with a mechanical activator in an activated state, consistent with some of the exemplary embodiments of the present disclosure;

FIG. 8C illustrates a sectional side view of a fresh-brewed coffee maker with an electrical activator, consistent with some of the exemplary embodiments of the present disclosure;

FIG. 9 illustrates a sectional side view of a daily dish heater 90 with two heater systems 10 and mechanical activators that one of them are in passive state and the other one is in activated state, consistent with some of the exemplary embodiments of the present disclosure;

FIG. 10A illustrates a sectional side view of a multi-purpose heater with a mechanical activator in a passive state, consistent with some of the exemplary embodiments of the present disclosure; and

FIG. 10B illustrates a sectional side view of a multi-purpose heater with a mechanical activator in an activated state, consistent with some of the exemplary embodiments of the present disclosure;

### DESCRIPTION OF EMBODIMENTS

The new features that are believed to characterize the current disclosure in terms of its structure, organization, use, and method of operation, along with its goals and benefits, are better understood from the following discussion.

The present disclosure introduces the exemplary embodiments of the application of the container which is included the fuel and activation mechanism. For example it can be utilized in Self-Heating products such as single-use food and beverage packaging, multi-use thermos, multi-use mug, and multi-use daily meal dish. The exemplary premixed fuel may include a group of substances which can be oxidized, a group of oxidizing substances which produce oxygen, a group of materials which controls the heat production, and a group of substances which control the consumption. These groups of substances which are named as a premixed fuel may be activated by a mechanical or electrical activator. When the mechanical activator turns from its passive state to the active state, a chemical starter which is covered by a membrane may be raptured by a moveable rod in a predesigned shape which is shaped by a heat resistant adhesive tape. The tape is stuck to the membrane to guide the rupture to be shaped in a predesigned way and avoid the torn membrane obstacles the exposure of the chemical starter with the premixed fuel. Therefore, when the rod is moved through the membrane, a spontaneous reaction may take place between the chemical starter and the premixed fuel and will continue through the premixed fuel as a self-sustained reaction. The movement of the holder can be either by the user or an electrical mechanism based on IOT, which enables the product to be connected to a smartphone or other smart devices. When the mechanical activator turns from its passive state to the active state, a soldering iron which is powered by a battery may heat the chemical starter which is covered by a membrane and combust the chemical starter. The heat which is produced by the combustion of the chemical starter may activate a reaction inside the premixed fuel and continues as a self-sustained reaction.

The exemplary embodiment of closed container, in which a premixed fuel and the activator are located may come in different shapes and sizes for various applications such as food and beverage packaging, heater for food delivery bags, heater for clothing, tents, blankets, or for other application such as heating buildings in remote areas in case of lack of electricity or other situations.

The premixed fuel may refer to four main groups of substances which formulated to generate oxygen, burn with oxygen, control the heat producing rate, and control the heat consuming rate. This exemplary premixed fuel can be positioned in an exemplary container in a compressed way to occupy much less space in order to decrease the container volume. In order to begin the fuel combustion, a large amount of activation energy is required. In exemplary embodiments, the fuel is completely inert until this huge amount of activation energy generates by the reaction between the chemical starter and the premixed fuel. The high amount of activation energy may hinder the combustion of the fuel in transportation, storage, carrying out by a human in mountains, and movement in a food delivery bag.

The exemplary container includes one of mechanical or electrical activator and the premixed fuel which may be positioned in a predetermined reaction path that was shaped by some walls or tubes in a way that a continuous reaction path was shaped. This reaction path can control the reaction rate to avoid overheating. Moreover, since this exemplary container may become so hot after activation, it should be in contact with either food or beverage content or an intermediate fluid to transfer its heat in order to avoid overheating. Overheating may cause sublimation of the premixed fuel materials and releasing sublimed gases which produce fume, smoke, and smell. The intermediate fluid can transfer heat in some application which the thing that should be heated is not a liquid such as dry foods, clothes, shoes, tents, closed spaces, etc. The intermediate fluid may have a high specific heat capacity to be warmed in a short time by the container and heat the dry space for a long period of time. In this regard, a Phase Change Material (PCM) can be employed to store the heat and transfer it.

When the exemplary activator triggered and the premixed fuel activated, an exemplary oxidizing material may produce oxygen and an exemplary oxidizable material may be burned by the produced oxygen. The exemplary oxidizable group of materials includes some of high energy density substances which can produce a lot of energy without generating any gas. By this combustion, a high amount of energy which is potentially stored in the high energy density substance will be released in a quick time. The exemplary group of oxidizable substances can be burned in the oxygen atmosphere produced by the group of oxidizing materials in a way that no gas may be produced or a negligible amount of gas will be produced. Instead of utilizing an exemplary high energy density group of oxidizable substances in the exemplary premixed fuel, a group of high mass density oxidizable substances has been selected. This means that this exemplary group of oxidizable materials has a lower molar energy density, which may cause to require less diluents to avoid the overheating phenomenon. Therefore, the exemplary premixed fuel has been formulated with considerably less material costs and may be embedded in a smaller container. For example, most of metals or metal alloys can be oxidized and produce metal oxides which are solid-state materials and may not produce gasses. Therefore, when they combust, a lot of energy may be released without producing a considerable amount of gas. Moreover, selecting the high mass density metals or metal alloys may cause to produce a higher amount of energy with less weight in comparison with other materials. Therefore, the exemplary group of oxidizable materials may include metals or metal alloys with a high mass density. The most important characteristics of the exemplary group of oxidizing materials may be a group of food-grade metals or metal alloys which are compact with a low activation energy and longtime reaction time with oxygen in a combustion way in order to simply control the reaction rate.

The exemplary group of oxidizable materials is consist of some substances with low rate of combustion in order to avoid overheating and increasing the risk of explosion. On the other hand, their rate of combustion is not too low to waste the consumer's time. In this regard, in addition to considering the type of metals or metal alloys, adjusting the particle sizes can be an important step to achieve a suitable combustion time for any kind of application of this exemplary fuel. To adjust the particle size, this should be considered that the larger particle size, the more required activation energy. On the other hand, the smaller particle size, the more expensive fuel material and the more required diluent to control the reaction rate.

In order to satisfy the above mentioned characteristics, a combination, mixture or an alloy of Lithium, Sodium, Magnesium, Aluminum, Manganese and Iron may be included in the exemplary group of oxidizable materials. This group of materials can be burned in an oxygen atmosphere and produces metal oxide or the oxide form of the element which is a solid-state material and technically does not release any gas except of a small amount of sublimed solids. Moreover, this exemplary group of oxidizable materials are food-grade materials and a small amount of them can be eaten by a human without any harmful effect. Accordingly, this group of materials may be employed with different particle sizes or may be mixed in various ratios and may be utilized with different compactness for a wide variety of application of this exemplary zero-emission fuel. Since the activation energy of the exemplary above mentioned materials is different, they can be used individually in different part of the container to reduce the required activation energy. For example, sodium and magnesium have a low activation energy and can be employed in the vicinity of the activator position to produce a high amount of energy by burning. This produced energy may provide the required activation energy for burning aluminum, manganese and iron in the exemplary group of oxidizable substances. Moreover, the particle sizes and the compactness may be different in various places of the exemplary premixed fuel in the exemplary container in order to be able to overcome the activation energy and facilitate the reaction process to be continuous.

The exemplary premixed fuel may also include an exemplary group of oxidizer materials which can produce the required oxygen for burning the above mentioned group of oxidizable materials in a closed space. This exemplary group of oxidizer materials may include metal oxides or the peroxide form of elements which can produce a large amount of oxygen through a decomposition reaction. The decomposition reaction of the exemplary group of oxidizer substances may take place by rising the temperature to the desired temperature. Therefore, the amount of oxygen in different parts of the exemplary container can be controlled by altering the type and amount of the oxidizer substance in that part. On one hand, a low decomposition temperature may cause over producing oxygen in the exemplary container which may cause the reaction rate increasing, overheating, and sublimed gas production. On the other hand, a high decomposition temperature may cause a high activation energy which may produce more gas by more chemical starter combustion either by mechanical or electrical activator. For this reason, the exemplary group of oxidizer materials may include oxidizer compounds with a specific decomposition temperature in a range above the working temperature of the product which is approximately above 80 Celsius degrees. Moreover, since the high temperature may cause more hazards, the composition temperature may be limited to 230 Celsius degrees.

In order to satisfy the above mentioned characteristics, the exemplary group of oxidizer materials may include at least one of or a combination or mixture of calcium permanganate, sodium permanganate, potassium permanganate, silver permanganate, sodium manganate, and potassium manganate. In the exemplary premixed fuel, the decomposition temperature of the exemplary group of oxidizer material may further be altered by adjusting the particle sizes of the mentioned oxidizers.

In an exemplary embodiment, the sublimed solids which were produced due to the combustion of the group of oxidizable materials may be stay in the exemplary closed container or may release from a semi-closed container. Since controlling this amount of gas in the container is dangerous and releasing it may cause some odors or fumes, which can annoy the consumer, the production of this gases should be controlled. In this regard, a group of materials which control the heat production and a group of materials which control the heat consumption may be employed to control the produced gas and avoid the overheating phenomenon.

The exemplary premixed fuel may also include an exemplary group of materials that control the heat consumption through the premixed fuel to absorb the heat in a hot region and transfer it to other parts of the exemplary container to avoid overheating. This may help the heat to be transferred from where the reaction is taking place and pre-heat other parts to speed up the process, and may act as a buffer, and prevent the reaction to be stopped. An exemplary group of substances that control heat consumption may have high melting and boiling points, be cost-effective, be food-grade, and above all they should have a high heat transfer coefficient, while having a low heat capacity. Moreover, they should not react with other group of materials and should absorb less heat in order to further transfer the heat.

In order to satisfy the above mentioned characteristics, the exemplary group of materials that control the heat consumption may include metal oxides which have high melting points and food-grade characteristics. The exemplary group of material for controlling the heat consumption may include metal oxides which are at least one of or a combination of ferric oxide, manganese dioxide, aluminum oxide, zinc oxide, magnesium oxide, and copper oxide.

In addition to three mentioned groups, the exemplary premixed fuel may include an exemplary material that can control the heat production by absorbing the extra heat in order to control the temperature and amount of oxygen which may be produced due to decomposition of oxidizers substances. This exemplary group of substances may have the same characteristics to the group of substances that control the heat consumption with higher heat capacity to absorb the surplus heat. An exemplary group of materials that can control the heat production may include at least one of FeO, MnO2, and Al2O3.

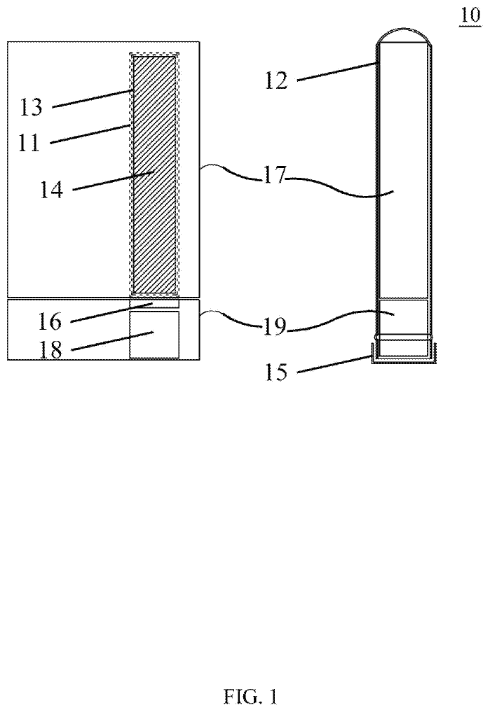

As it is illustrated in FIG. 1 a heater system 10 of the present disclosure, consist of some of the exemplary components. In an exemplary embodiment, the heater system 10 may include a combustion chamber 12, which contains a thermal battery 17 and an activator 19. The thermal battery 17 may consist of a premixed fuel 14, which may be positioned in a thin metal foil 13 and a thin metal mesh 11. These components which are named a thermal battery and can be sold separately may be placed next to an activator 19 in an exemplary combustion chamber 12 to be activated and generate a huge amount of heat. An exemplary activator 19 may include a chemical starter 16 which is coupled with an initiator 18. In an exemplary embodiment, activator 19 may include either mechanical or electrical initiator 18.

In an exemplary embodiment, when the user wants to initiate the reaction to exploit the generated energy, either mechanical or electoral initiator 18 moves or heats the chemical starter 16 which is adjacent to the thermal battery 17 to trigger an exothermic reaction among the sustainable solar rechargeable zero-emission energy carrier or premixed fuel 14. This can provide the required amount of energy to overcome the activation energy barrier of the premixed fuel 14. The required activation energy to start the reaction among the premixed fuel 14 may be high to prevent inadvertent starting in transportation. Therefore, unless the activator 19 provides the required activation energy, the premixed fuel 14 is inert and safe.

In an exemplary embodiment, the combustion chamber 12 may be made of a light and durable material with a high heat-transfer coefficient which can tolerate high temperatures and does not rust or erode in a liquid beverage or food. In an exemplary embodiment, the combustion chamber 12 may be designed with different concepts according to the required application. As an example, which is shown in FIG. 1, in an exemplary embodiment, combustion chamber 12 may be designed in the form of a tall cylindrical shape to increase the boundary surface area and to decrease the surface area of the bottom of the combustion chamber 12 which is not used for heat transferring. Although, it is understandable that other shapes and sizes of combustion chamber 12 are also possible, in practice, based on the required application the amount of heat transfer should be as much as possible.

As it is mentioned in the above paragraphs, in an exemplary embodiment, the oxidizable materials may include a combination, mixture or an alloy or at least one of Lithium, Sodium, Magnesium, Aluminum, and Iron. In an preferable exemplary embodiment, the oxidizable materials may consist of 0.01 to 0.1 wt. % of lithium, 0.05 to 0.2 wt. % sodium, 0.1 to 0.4 wt. % of magnesium, 10 to 25 wt. % of aluminum, 7 to 14 wt. % of manganese, and 20 to 45 wt. % of iron. In an exemplary embodiment, the average particle size would be between 2 and 200 micron.

In an exemplary embodiment, a combination, mixture or an alloy of the oxidizable materials may include at least one of Lithium, Sodium, Magnesium, Aluminum, manganese, and Iron in a way that the auto ignition temperature is set between 270° C. to 420° C. based on the distance to the activator, a density between 4 g/cm³ to 12 g/cm³.

In an exemplary oxidizable materials, since altering the average particle size may alter the activation energy, different particle sizes may be placed in different parts of the thermal battery 13. As an example, smaller particles may be placed near the activator 19 components and gradually larger particles may be placed where controlling the reaction rate and the temperature is critical. Therefore, the density of the premixed fuel 14 may be different in different parts of the thermal battery 17. In order to avoid disarrangement of particle sizes during shipment, the premixed fuel 14 may be compressed suitably in several steps when it is poured in the exemplary thin metal foil 13 which is structured by the metal mesh 11.

Supplying the high activation energy of the exemplary premixed fuel 14 may be challenging, however, this may remain the premixed fuel 14 more stable in the thermal battery 17 in order to prevent inadvertent activation in shipping and carrying out by the user. As a result, it may be considered as a key advantage in shipping and storage.

In an exemplary embodiment, the reaction rate may be related to ratio of oxygen production. The lack of oxygen may decrease the reaction rate and also may cause the reaction to be stopped and extinguished. On the other hand, surplus oxygen production may increase the reaction rate and also the excess oxygen may cause an explosion.

In an exemplary embodiment, the group of oxidizer materials may include oxidizer compounds with a specific decomposition temperature in a range of 80° C. to 230° C. In an exemplary embodiment, the group of oxidizer materials may include at least one of or a combination or mixture of calcium permanganate, sodium permanganate, potassium permanganate, silver permanganate, sodium manganate, and potassium manganate. In an exemplary embodiment, the average particle size of the exemplary group of oxidizer materials may be between 20 and 150 microns based on their distance to the activator. In an exemplary embodiment, the oxidizing agent may include 5 to 15 wt. % calcium permanganate, 15 to 35 wt. % sodium permanganate, 25 to 65 wt. % potassium permanganate, 1 to 5 wt. % silver permanganate, 5 to 25 wt. % sodium manganate, and 10 to 35 wt. % of potassium manganate, based on the total weight of the premixed fuel 14.

In an exemplary embodiment, the materials that control the heat consumption may include at least one of or a combination of ferric oxide, manganese dioxide, aluminum oxide, zinc oxide, magnesium oxide, and copper oxide. In an exemplary embodiment, the optional materials that control the heat consumption may include 2 to 5 wt. % ferric oxide, 4 to 12 wt. % manganese dioxide, 10 to 25 wt. % aluminum oxide, 1 to 3 wt. % zinc oxide, 10 to 15 wt. % magnesium oxide, and 1 to 5 wt. % copper oxide based on the whole weight of the premixed fuel 14. In an exemplary embodiment, the optional materials that control the heat consumption may have a melting point higher than 1500° C. with a heat-capacity of approximately 70 J/(mol K).

In an exemplary embodiment, the optional material that can control the heat production may Include at least one of FeO, MnO2, and Al2O3. In an exemplary embodiment, the material that can control the heat production may include 2 to 10 wt. % of FeO, 5 to 12 wt. % of MnO2, and 10 to 35 wt. % of Al2O3 based on the whole weight of the premixed fuel 14.

In an exemplary embodiment, The premixed fuel 14 may include oxidizer material, oxidizable material, heat production controlling material, and heat consumption controlling material which has been mentioned above. In any case, the exemplary premixed fuel 14 may be mixed based on stoichiometric ratios, but the other materials may be altered based on the possible range of price, compactness, and volume.

As it was mentioned, in an exemplary embodiment, the activator 19 may be either mechanical or electrical. The selection of mechanical or electrical activator may be depend on the required application of the heater. In an exemplary embodiment, the mechanical activator may be utilized in single-use products such as single-use aluminum or tin cans and paper cups, whereas the electrical activator may be used in multi-use products such as mugs, thermoses or daily dishes. In an exemplary embodiment, both of mechanical and electrical activators may include a chemical starter 16 which is coupled with an initiator 18 mechanism. In an exemplary embodiment, the mechanical activator may activate by the user with just a simple movement of a component in the initiator 18, which cause the chemical starter 16 to be in contact with the premixed fuel 14. This may cause a spontaneous reaction take place between the chemical starter 16 and the premixed fuel 14, which can provide the required activation energy. In an exemplary embodiment, the electrical activator may be activate by a wired or wireless command of the user and may turn on a soldering iron in the initiator 18. This may cause the chemical starter 16 to be warmed up and be burnt in the premixed fuel 14, which can provide the required activation energy. The chemical starter 16 may be different in case of mechanical or electrical activators. In an exemplary embodiment, the mechanical activator may include a chemical starter 16 such as propylene glycol, hydrogen peroxide, sulfuric acid and a cotton or wood pulp made fibre. Utilizing these materials may empower the product to work even in a freezing conditions on the top of the mountains or poles due to the low melting point of the chemical starter. When the chemical starter 16 comes into contact with the premixed fuel 14, a spontaneous reaction may take place which may produce an intense hot spot that can provide the required activation energy. In an exemplary embodiment, the electrical activator may include a chemical starter 16 such as red phosphorous, cellulose, a cotton or wood pulp made fibre, sulfur, magnesium, and aluminum. When the soldering iron in the initiator 18 heats the chemical starter 16, the chemical starter 16 may be burnt which may produce an intense hot spot that can provide the required activation energy.

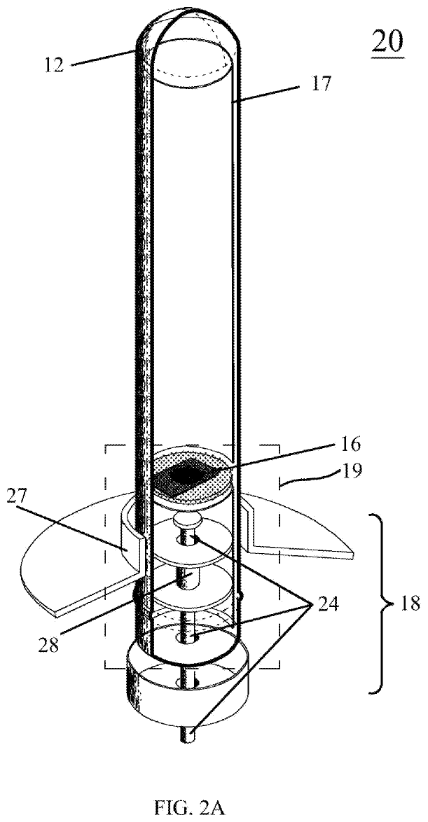

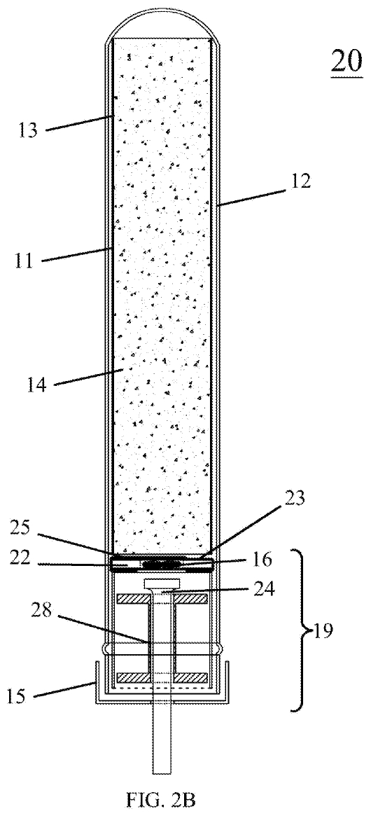

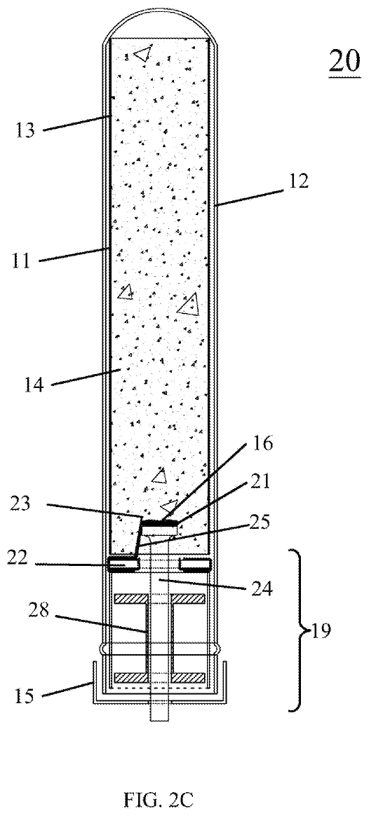

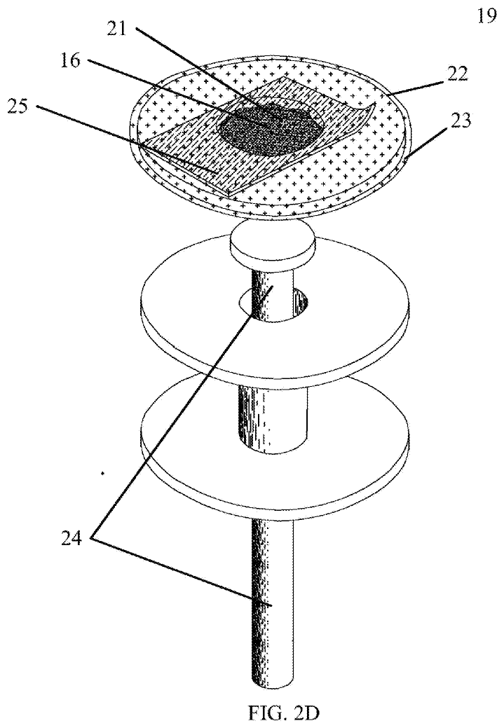

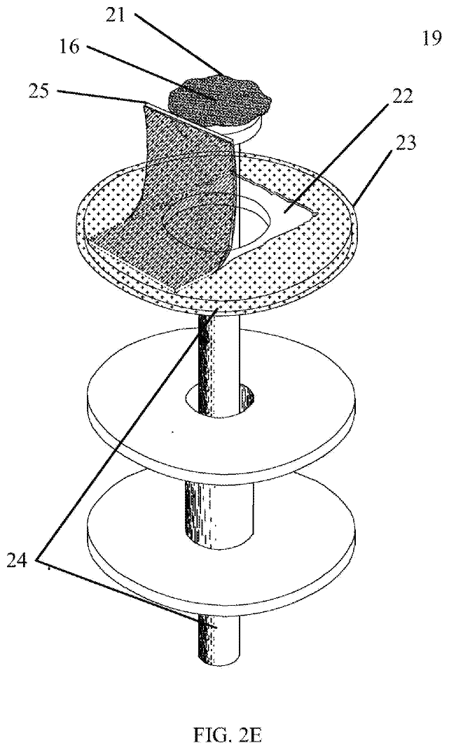

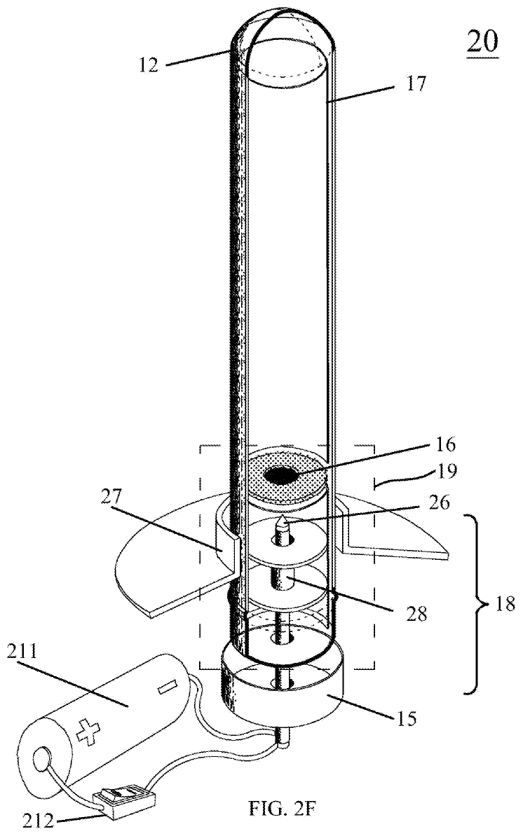

FIG. 2A shows an exemplary embodiments of this disclosure in a perspective view of heater system 20 with a mechanical activator. FIG. 2B shows an exemplary embodiments of the heater system 20 in a sectional side-view, which has a mechanical activator in a passive state. FIG. 2C shows an exemplary embodiments of the heater system 20 in a sectional side-view, which has a mechanical activator in an activated state. FIG. 2D shows an exemplary embodiments of a mechanical activator 19 in a perspective view, which is in a passive state. FIG. 2E shows an exemplary embodiments of mechanical activator 19 in a perspective view, which is in an activated state. FIG. 2F shows an exemplary embodiments of this disclosure in a perspective view of heater system 20 with an electrical activator.

As it can be seen in all of the exemplary embodiments illustrated in FIGS. 2A-2F, the heater system 20 may include a combustion chamber 12 which may be as same as the combustion chamber 12 in FIG. 1. Referring to FIGS. 2A-2F, the exemplary combustion chamber 12 may further include an activator 19 which alternatively may be mechanical or electrical. Both of these activators have a chemical starter 16 and an initiator 18 inside the combustion chamber 12. In an exemplary embodiment, the premixed fuel 14 which is positioned in a thin metal foil 13 and a thin metal mesh 14 may be placed in the upper portion of the combustion chamber 12 and the activator 19 may be positioned in the lower portion.

As it is illustrated in FIGS. 2A-2F, in an exemplary embodiment, the chemical starter 16 may be absorbed by a fibre 21. The fibre 21 may be positioned in the hole of a circular surface 22 in a way that it is completely sealed by a metal tape 23. In an exemplary embodiment, the metal tape may be made of an aluminum or brass tape. This may hinder the premixed fuel 14 to be mixed with the chemical starter 16 and may avoid any kinds of inadvertent activation in the movement of the heater system 20 in transportation and storage.

In case of the mechanical activator, which is illustrated in FIGS. 2A-2E, the metal tape 23 may be ruptured by a rod 24 to expose the chemical starter 16 and the premixed fuel 14 which may cause to start a spontaneous reaction. When the rod 24 moves by the user, it may punches the metal tape 23 in a predesigned way. A normal rupture on the metal tape 23 by the rod 24 cannot expose the chemical starter 16 to the premixed fuel 14, because the remained part of the metal tape 23 covers the chemical starter 16 and the premixed fuel 14 cannot have enough contact with the chemical starter 16 to start the spontaneous reaction between them. For this reason, as it is illustrated in FIGS. 2D-E, a ribbon 25 which is stuck to the bottom part of the metal tape 23 may be guide the metal tape 23 to be ruptured or punched in a predesigned shape. In an exemplary embodiment, this ribbon 25 may cover all the hole of the circular surface 22 and may continue to one optional direction of the circular surface 22 to make the metal tape 23 stronger in the predesigned rectangular shape. Therefore, when the rod 24 punches the metal tape 23, the metal tape 23 may be ruptured in the predesigned shape and may not cover the fiber 21 to be exposed with premixed fuel 14 as it is illustrated in FIG. 2E. In an exemplary embodiment, the movement of the rod 24 by the user may be switched the product from a passive state into an active state.

In case of the electrical activator, which is illustrated in FIG. 2F, the exemplary soldering iron 26 warms the chemical starter 16 to provide its activation energy in order to burn it up. The heat which can be produced from the combustion of the chemical starter 16 can provide the required activation energy of the premixed fuel 14 to start the reaction. In an exemplary embodiment, the soldering iron 26 may be powered by a battery 211. The battery 211 may be connected to the soldering iron 26 with clicking on a button 212 by the user which may switch the product from a passive state into an active state.

In an exemplary embodiment, the chemical starter 16 may be different in case of the mechanical activator, which is shown in FIGS. 2A-2E, and the electrical activator, which is shown in FIG. 2F. In an exemplary embodiment, the mechanical activator may include a chemical starter 16 such as propylene glycol, hydrogen peroxide, sulfuric acid and a cotton or wood pulp made fibre. The exemplary rod 24 may path through a holder 28 which can hold the rod 24 to be exactly in the suitable position and direction. Furthermore, the exemplary holder 28 may guide the movement of the rod 24 to exactly go into the hole of the circular surface 22 in order to punch and puncture the metal tape 23. In an exemplary embodiment, the rod 24 may further pass through the lid 15 of the combustion chamber 12 to be available for moving by the user. In an exemplary embodiment, the electrical activator may include a chemical starter 16 such as red phosphorous, cellulose, a cotton or wood pulp made fibre, sulfur, magnesium, and aluminum. The exemplary soldering iron 26 may path through a holder 28 which can hold the soldering iron 26 to be exactly in the suitable position and direction. The hottest spot of the soldering iron 26 which is located on the top of it may go through the hole of the circular surface 22 to reach the chemical starter 16. When the user push the button 212, the soldering iron may burn the chemical starter 16 which may switch the product from a passive state into an active state.

As it is shown in FIGS. 2A-F the exemplary heater system 10, which is similar to the heater system of FIG. 1 may be integrated with a washer 27 to seal the heater system 10 and other containers. In an exemplary embodiment, the washer 10 may connect the heater system 10 to a container which contains something that should be warmed up such as liquids, beverages, foods, or intermediate fluids. In an exemplary embodiment, the washer 27 may be in contact with edible thing in a high temperature, therefore, it may be made from a food grade material which can resist high temperatures. In order to decrease the temperature that this washer 27 should bear, it is positioned lower than the premixed fuel 14 with a considerable distance to avoid the temperature of this place reach more than 100° C. This may help the product to be cheaper and may easily be integrated to any kind of containers or products.

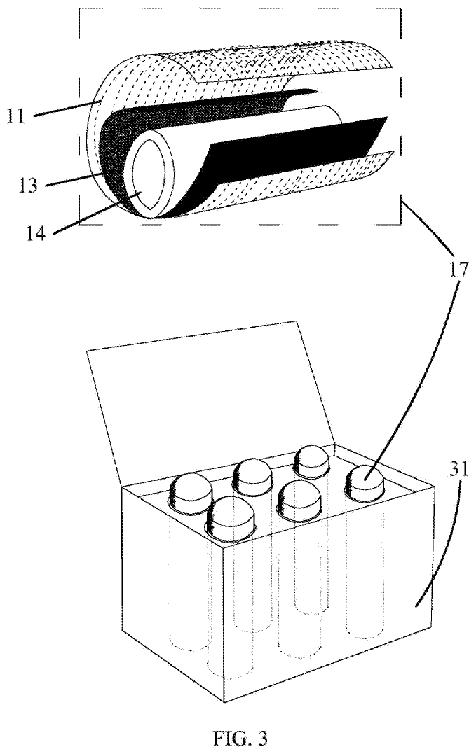

FIG. 3 shows an exemplary embodiments of the components and packaging of the thermal batteries 17 in a perspective view. In an exemplary embodiment, the thermal battery 17 may be optionally poured into a cylindrical shape which is made from a thin metal foil 13 and a thin metal mesh to be sold individually. In an exemplary embodiment, the thermal battery 17 may be sold in shops separately in a package 31 consist of alternatively some pieces of the thermal battery 17. The package 31 of one to several thermal batteries 17 may be sold independently from other products which are disclosed in the present disclosure to be removed and replace in the products. In an exemplary embodiment, the metal foil 13 can seal the premixed fuel 14 to hinder it to be spilled out and also may be protected by a metal mesh 11 to be broken. In an exemplary embodiment, the thermal battery 17 may surrounded by the exemplary metal mesh 11 which is a structure that may sustain the metal foil to shape the thermal battery as an independent product that can be sold and carried out by the user.

In an exemplary embodiment, the exemplary metal mesh 11 may help the heat to be transferred easily to the combustion chamber 12 without any obstacle. Furthermore, the exemplary metal foil 13 may help the thermal battery 17 to be easily removed and replaced in the combustion chamber 12 by the user due to slippery surface of the metal mesh 11 and its suitable flexibility. In an exemplary embodiment, the user can buy thermal batteries 17 in a package 31 and put each thermal battery 17 into the combustion chamber 12 and use it and then replace it easily with another one. In an exemplary embodiment, the used thermal batteries 17 can be placed again in the package 31 and may be come back to the producer company by the deposit system to be recycled and recharged by solar energy in the company. This may make an advantage to be less harmful for the environment and also helps to reduce the global warming by heating foods and beverages and other things with solar energy.

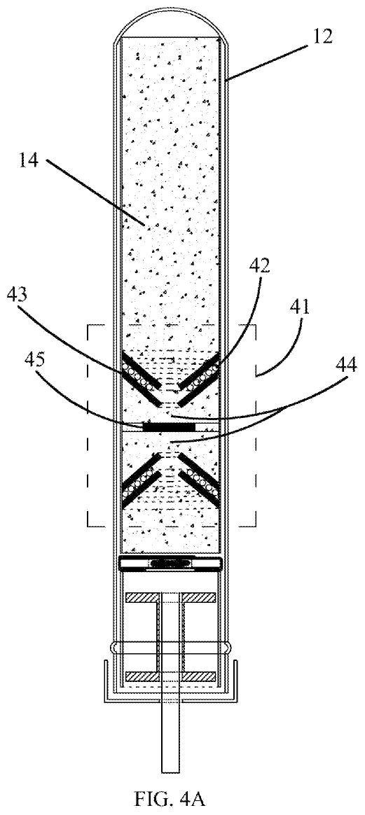

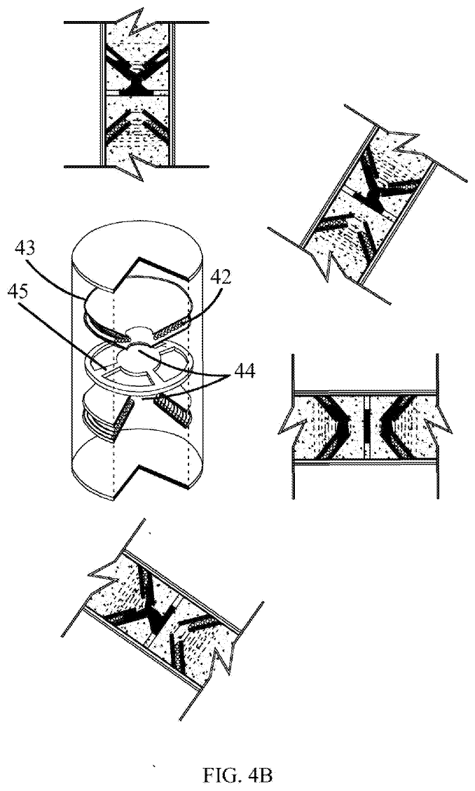

In an exemplary embodiment, the heater system 10 may optionally has an extinguisher system 41 which can stop the reaction inside the thermal battery 17 by blocking the reaction path. In an exemplary embodiment, the heater system 10 may be activated inadvertently in some situations like an accident or the low quality of production. In these cases, the product needs to have an optional extinguisher to stop the reaction. FIG. 4A illustrates the exemplary optional extinguisher system 41 which may be activated with melting a material which can block the reaction path in any situation regardless of the angle of the product with the gravity force. This exemplary extinguisher system 41 must work in any situation and may not be depend on the position of the heater system 10 and its angle. It must be able to suppress or extinguish the combustion in any situation to increase its safety. In an exemplary embodiment, the heater system 10 may include an optional extinguisher system 41, which include soldering wire 42 with a melting point in the range of 250° C. and 450° C. When there is not anything surrounding the combustion chamber 11, the heat cannot be transferred out and this may increase the temperature inside the combustion chamber 11. In this case, when the temperature reaches 250° C. the soldering wire may melt in the predesigned funnels 43.

FIG. 4B illustrates a perspective view the exemplary extinguisher system 41 and some side-sections of this system in different angles. In an exemplary embodiment, the extinguisher system 41 is designed to be symmetrical both vertically and horizontally to stop the reaction in any situations and angles. In an exemplary embodiment, the soldering wire 42 may be twisted between a pairs of funnels 43 in a way that the funnels 43 can lead them to be organized. The pairs of funnels 43 may also lead the melted soldering wire 42 to flow through them and spill to the narrowed path 44 in order to block the reaction path. When the reaction accidentally started by the activator 19, and there is not anything to transfer the produced heat because of the content leakage which was disposed with the combustion chamber 12 the extinguisher system 41 may stop the reaction by blocking its path. In an exemplary embodiment, when the reaction inadvertently activated and there is nothing to transfer the heat out of the heater system 10, the reaction goes through the first and second pairs of funnels and melt the soldering wire which can flow into the narrowed path 44 and stops the reaction. In case of being vertically, there should be enough time to melt the soldering wire 42 and flow to the narrowed path 44. Therefore a disk 45 may be positioned in the narrowed path 44 to divert the reaction path. In exemplary embodiments, the utilization of a disk 45 which occupied the center of the narrowed path 44 may allow for prolonging the reaction time and provide the required time for melting and flowing the soldering wire 42 to the predesigned narrowed path 44.

In an exemplary embodiment, the washer 10 may provide a possibility to integrate the heater system 10 with other products with the least changes in that product and the production line in the factory. This may make an advantage for food and beverage producing companies or packaging companies or other potential cooperative companies to integrate this product into their products with the least changes in their product and their production line. In an exemplary embodiment, such an integration with just a simple washer 10 may empower the heater system 10 to be integrated with other product by penetrating just a hole on the bottom surface of that product. As it will be described, the heater system 10 may be integrated to other products easily just by putting the washer 10 in a hole on the bottom surface of that product. After putting the washer 10 in the penetrated hole on the bottom surface of that product, the combustion chamber 12 may easily be positioned in the washer by pushing it through the washer.

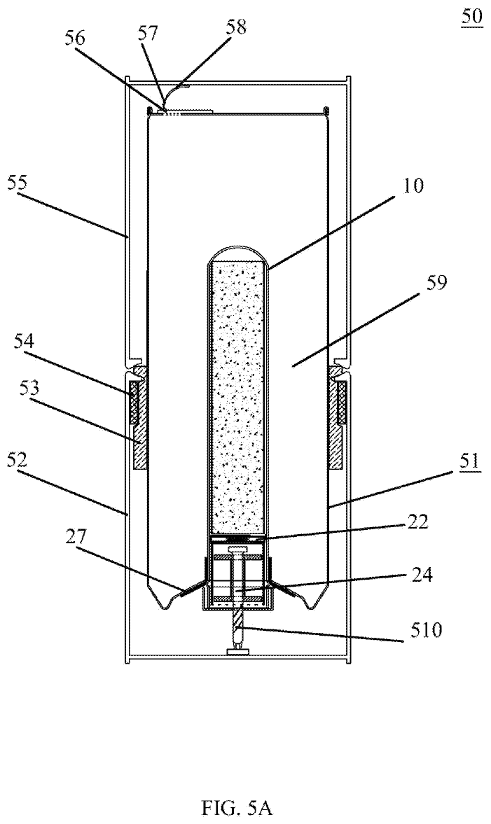

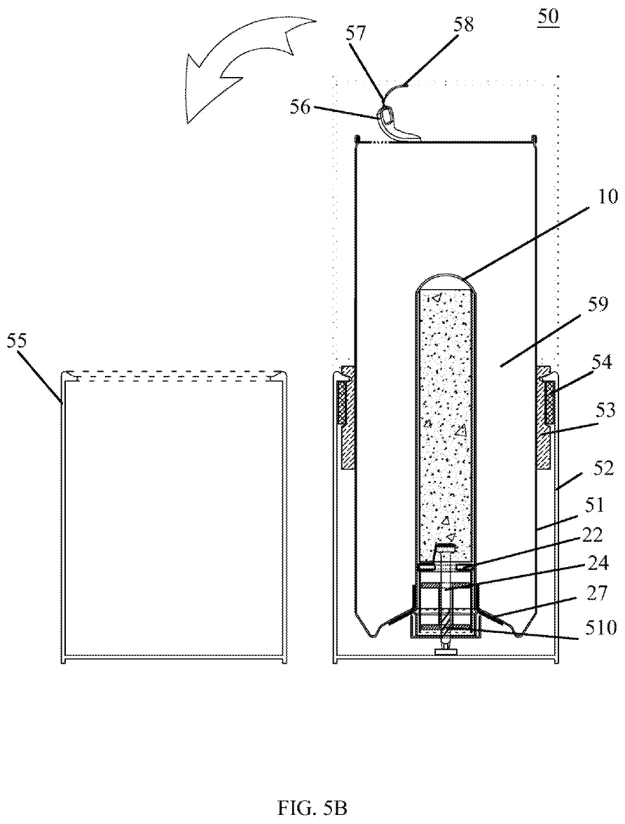

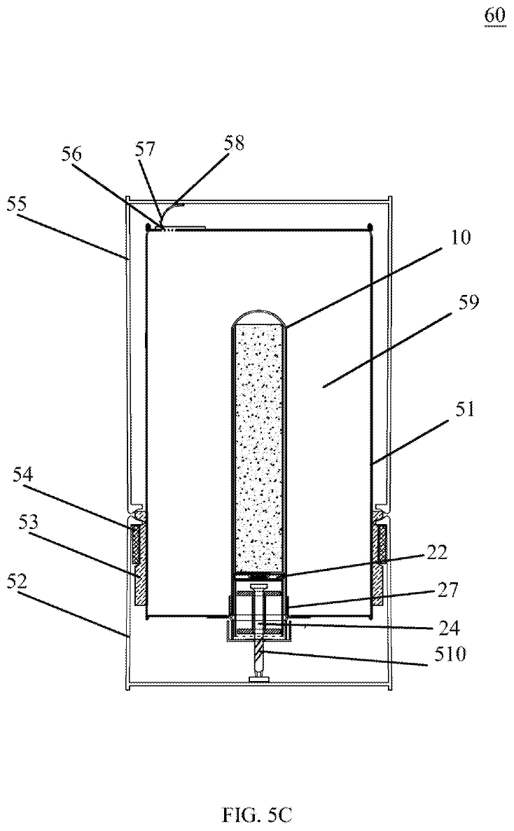

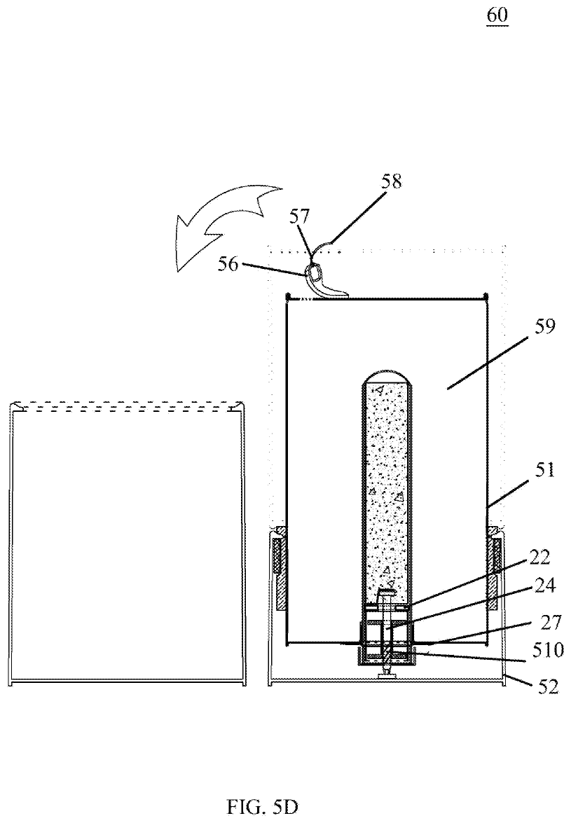

FIGS. 5A, 5C shows an exemplary embodiments of a sectional side view of an aluminum can heater 50 with a mechanical activator in a passive state. In an exemplary embodiment, the heater system 10 may be integrated with a can or a regular aluminum can 51 in order to warm up its content 59, which is consist of some exemplary embodiments of this disclosure. Regular aluminum cans and tin cans are widely used in food and beverage industries and are very popular in self-heating technology. Most of the existing self-hearting products change the majority of design and production line of products to be integrated with them, however, the present disclosure may make an advantage to integrate the heater system 10 as easy as possible into other products and do not change the product design and the production line. In an exemplary embodiment, the heater system 10 may be integrated to the can 51 by a washer 27. The washer 10 may seal the heater system 10 and the can 51 in order to prevent the content leakage.

In an exemplary embodiment, the can 51 may be positioned into a container in order to protect the user's hand from touching the hot parts of the can after activating the product. When the product activated by the user, the bottom part of the can which is in the vicinity of the heater system 10 may get a high temperature and the container 52 may prevent the user's hand to be burnt. In an exemplary embodiment, the container 51 may further prevent the possible fumes which may be produced due to the activation reaction or the reaction among the premixed fuel 14 to be released into atmosphere freely. These fumes may be produced during the reaction by burning the impurities of the materials or by sublimation of the materials in high temperatures. The possible fumes are negligible due to the shape of the combustion chamber 12 which has been designed to have the most contacting surface area in order to reach the most possible heat transfer and therefore to reach the lowest temperatures in the combustion chamber 12. The user may be annoyed by the released fumes or their smells, therefore, the fumes may be filtered out by a filter 53. In an exemplary embodiment, the filter 53 may be made from an activated carbon or any other possible filters that can filter out the sublimed materials, fumes, and smells. The exemplary filter may be stuck to the container 52 by a two sided tape 54 or any kind of adhesive materials.

In an exemplary embodiment, the exemplary can 51 may be positioned in a container 52 to cover the bottom part of the can 51 and a cup 55 may be positioned on top of that to cover the upper part of the can 51. In an exemplary embodiment, the cup 55 may be used as a glass to spill the content 59 into it to facilitate eating or drinking by the user. Since the can may be warmed up after the activation and it is difficult for the user to drink or eat from it, the cup 55 may provide the possibility to spill the hot content into it.

FIGS. 5B, 5D shows an exemplary embodiments of a sectional side view of a can heater 50 with a mechanical activator in an activated state. In an exemplary embodiment, the user may open the product by picking up the cup 55 and pushing the can 51 downward. This may move the can 51 down which may cause to move the rod 24 through the hole of the circular surface 22 and punch the metal tape 23 to activate the product. In an exemplary embodiment, the movement may be a rotational movement around the vertical axis which transform to a directional movement by means of a threaten path on a screw 510. When the user activates the product, the content 59 may be boiled and this may cause to increase the volume of the can 51 and ultimately blasting the can. In order to prevent blasting of the can 51 after activation, it is important to make sure that the lid 56 was opened before activating the product which may allow to release the boiled content 59 and may prevent blasting. In an exemplary embodiment, the product may further have a handle 57 that is tied to the lid 56 and stuck to the cup 55 by an adhesive material 58. When the user wants to pick up the cup 55 in order to activate the product, the handle 57 may pull the lid 56 and open it in order to prevent the aluminum can 51 to be blasted by the boiled content 59 after activation.

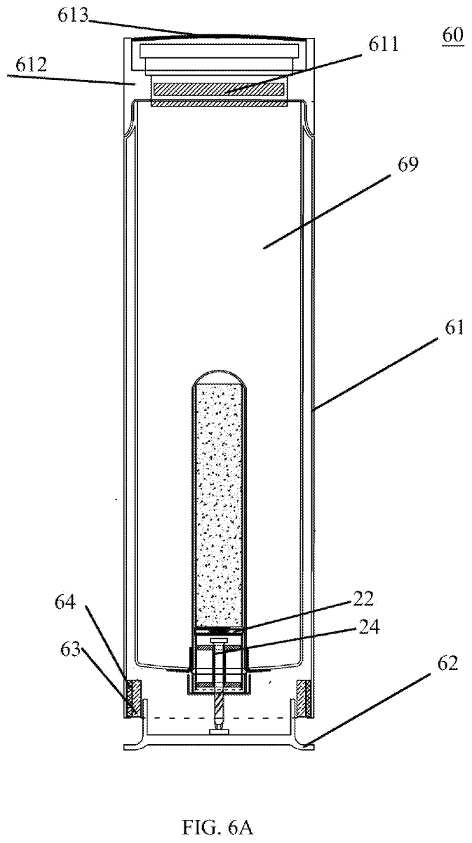

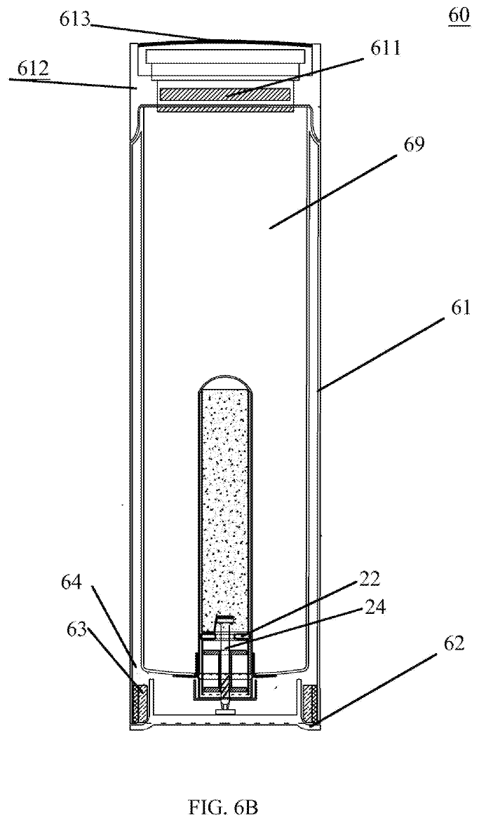

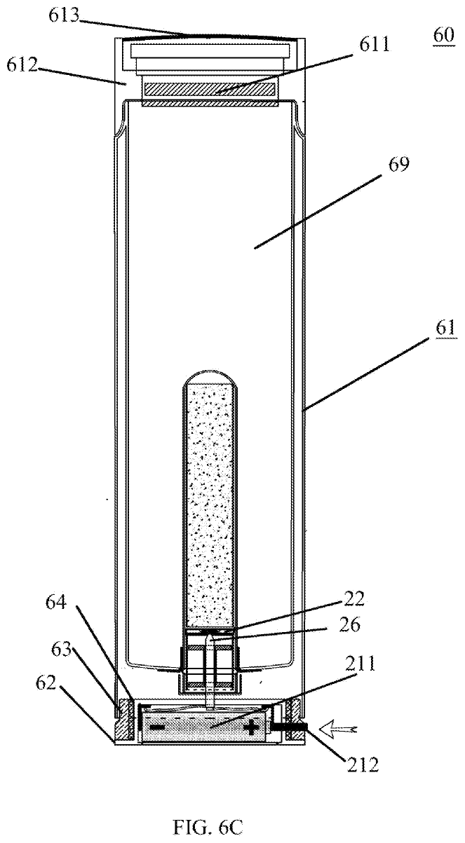

FIG. 6A shows an exemplary embodiments of a sectional side view of a smart thermos heater 60 with a mechanical activator in a passive state, which is consist of some exemplary embodiments of this disclosure. In an exemplary embodiment, the heater system 10 may be integrated with any kind of thermoses 61 in order to warm up its content 69, Thermoses are widely used and very popular in customers' daily routine and users would like to warm up their beverages into them because sometimes they have to be out of home for a long time and prefer to warm up their desirable content. This may be more important for mothers or parents who take their beloved children out and are always worried about feeding their infant out of home. They always need enough boiled water to make an infant formula out of home. They can make the infant formula with self-heating technology in this smart thermos 60 and spill the ready to eat infant formula into a baby bottle. In an exemplary embodiment, the heater system 10 may be integrated to the thermos 61 by a washer 27, which may seal the product in order to prevent the content leakage.

In an exemplary embodiment, the smart thermos 61 may have a bottom cover 62 in order to prevent the user's hand to be burnt and prevent the produced fumes to be released and annoy the user by the released fumes or their odors. In an exemplary embodiment, the fumes may be filtered out by a filter 63, which is made from an activated carbon or any other possible filters and is suck to the cover 52 by a two sided tape 54 or any kind of adhesive materials.

In an exemplary embodiment, the exemplary smart thermos 60 may further have a thermometer 611 on its lid 612, where the temperature has the highest amount because of the convection inside the content 69. In an exemplary embodiment, the thermometer 611 may be coupled with a touch screen display to show the user the temperature inside the thermos. This touch screen thermometer 613 not only make the thermos beautiful and make the user excited but also may provide a facility for mothers to know when the temperature is suitable for their children.

FIG. 6B shows an exemplary embodiments of a sectional side view of a smart thermos heater 60 with a mechanical activator in an activated state. In an exemplary embodiment, the user may push or twist the cover 62 and this may move the rod 24 through the hole of the circular surface 22 and punch the metal tape 23 to activate the product. In an exemplary embodiment, the smart thermos 60 may be made of two metal layers in order to prevent heat loss of the content and provide an extra space to keep the produced fumes.

FIG. 6C shows an exemplary embodiments of a sectional side view of a smart thermos heater 60 with an electrical activator. In an exemplary embodiment, the user may push the button 212 or twist the cover 62 to connect the battery 211 with the soldering iron 26 as same as the heater system 10 that was described in FIG. 2F. Other specifications of the thermos with electrical activator are same as the thermos with mechanical activator, however, the design of the cover may be different to include the battery 211 and the button 212.

In an exemplary embodiment, the multi-use thermos 61 may have a cover 62 which can be opened and make an accessibility to the lid 15 of the combustion chamber 12. In an exemplary embodiment, the user can open the cover 62 and the lid 15 to remove and replace the thermal battery 17 which is discussed in FIG. 3. The thin metal foil 13 and the thin metal mesh 11 can sustain the structure of the thermal battery 17 before and after the activation in order to replace easily by the user. After the reaction, since the remained material of premixed fuel 14 may be solidified by the high temperature of the reaction, when the user take it out from the combustion chamber 12, it may not pour as a powder and it may became completely solid like a piece of iron. The remained material may be put in the package 31 and come back to the company by the deposit system and may be recycled and recharged by solar energy in the producer company.

In an exemplary embodiment, the remained material after the reaction may be come back to the company and the company melt them by solar energy to recycle and recharge them. In an exemplary embodiment, the remained material are mostly metal oxides which can be transformed to metals by melting. This process may require high temperatures and a solar concentrator may be utilized in order to melt all the remained material which may come back to the company. When all the remained materials are melted, due to their different densities, they may organized vertically in the molten furnace and this may be helpful to separate all the materials. After this process, the metals may be turn into powder and mixed with other materials and oxidizers in order to rebuild the premixed fuel 14. In an exemplary embodiment, the used thermal battery 17 may include metal oxides and can be melted by a solar concentrator in the company in order to exploit metals from metal oxide and rebuild the premixed fuel 14 by the remained material which may come back to the producer company or its partner by the deposit system devices in super markets. The deposit system collects food and beverage packaging in order to recycle them in developed countries. The user may take advantage from the deposit system's cash back to the consumers and get a discount for buying a new package 31 of thermal batteries 17.

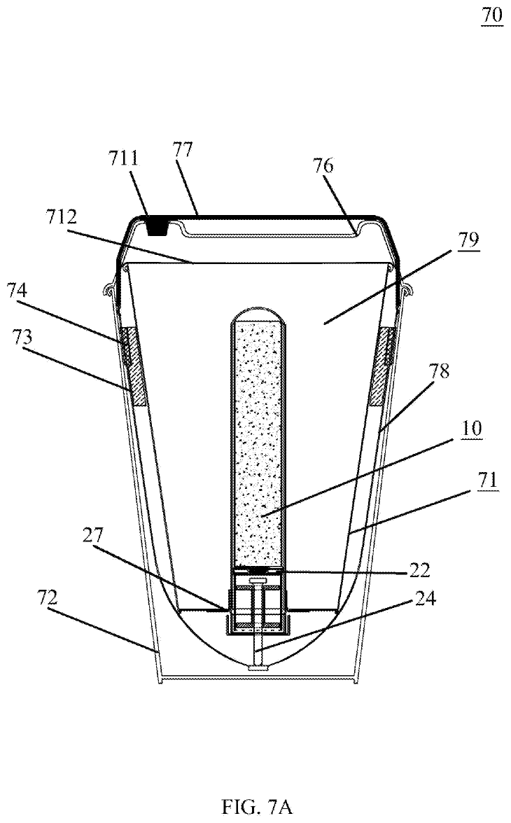

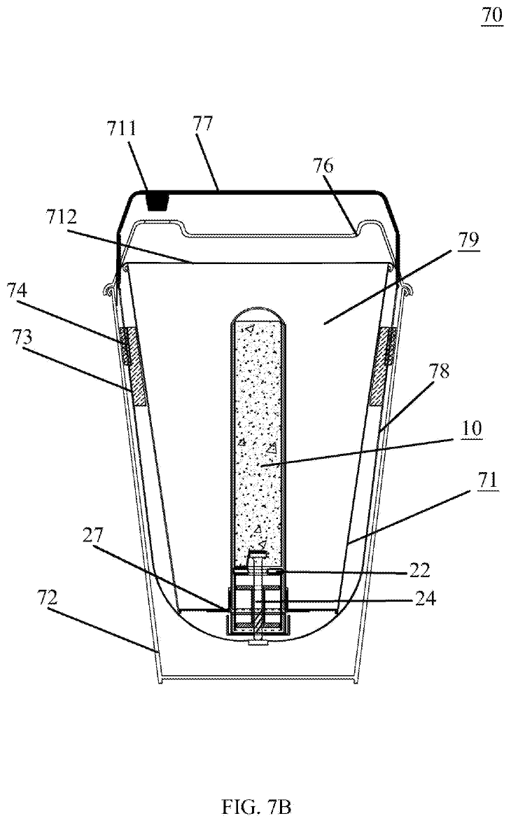

FIG. 7A shows an exemplary embodiments of a sectional side view of a disposable cup heater 70 or a mug heater or paper packaging heater with a mechanical activator in a passive state. In an exemplary embodiment, the heater system 10 may be integrated with any kind of disposable cups 71 in order to warm up its content 79, which is consist of some exemplary embodiments of this disclosure. Disposable glasses are widely used and very popular in customers' daily routine and users would like to warm up their beverages into them. Having a self-heating disposable cups may help this technology to be more environmentally friendly at more reasonable price. In an exemplary embodiment, the heater system 10 may be integrated to the disposable cup 71 by a washer 27, which may seal the product in order to prevent the content leakage.

In an exemplary embodiment, the disposable cup 71 may be placed into a cup-shaped vessel 72 in order to prevent the user's hand to be burnt and prevent the produced fumes to be released and annoy the user by the released fumes or their odors. In an exemplary embodiment, the fumes may be filtered out by a filter 73, which is made from an activated carbon or any other possible filters and is suck to the vessel 72 by a two sided tape 74 or any kind of adhesive materials.

FIG. 7B shows an exemplary embodiments of a sectional side view of a disposable cup heater 70 or a mug heater or paper packaging heater with a mechanical activator in an activated state. In an exemplary embodiment, the user may pull a handle 77 which is passed through the lid 76 of the product to activate the product. When the user pulls the handle 77 which is connected to a cotton 78, the cotton 78 may move the rod 24 through the hole of the circular surface 22 and punch the metal tape 23 to activate the product. In an exemplary embodiment, the handle 77 may optionally be connected to a cap 711 which is placed on the lid 76 of the product to seal the product to prevent content leakage. The product may further have a sealing cover 712 on the disposable cup 71 in order to seal the content 79. In an exemplary embodiment, when the user pulls the handle 77, the cap 711 may be moved with the handle 77 and open the lid 76 in order to drink the content 79. In an exemplary embodiment, the disposable cup heater 70 may be made of two paper layers in order to prevent heat loss and provide an extra space to keep the produced fumes.

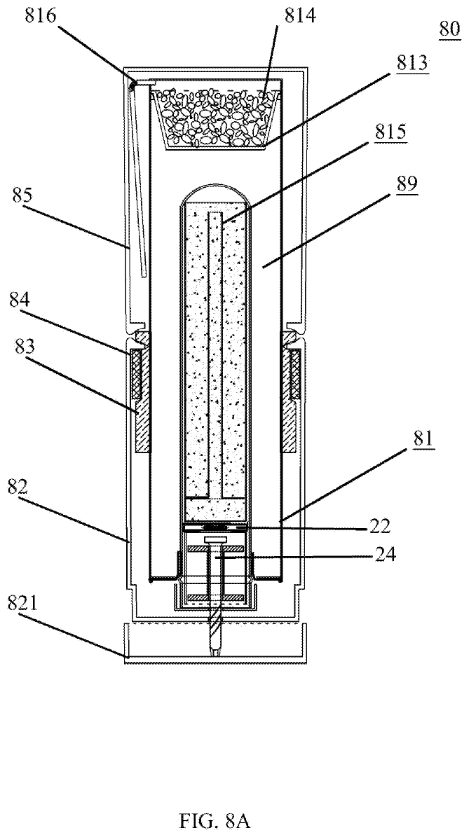

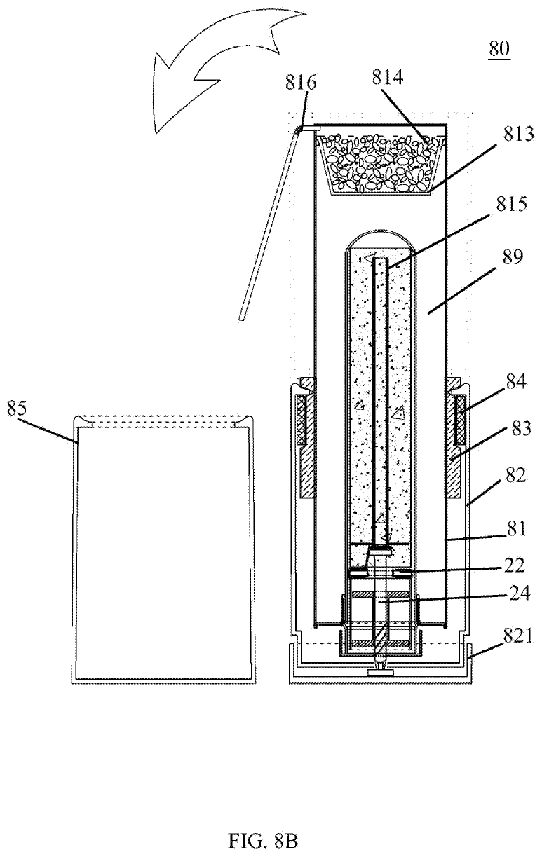

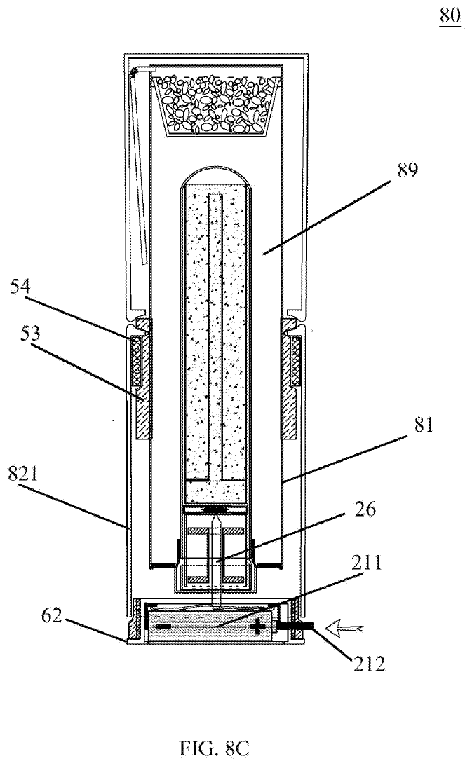

FIG. 8A shows an exemplary embodiments of a sectional side view of a fresh-brewed coffee maker 80 or tea brewer with a mechanical activator in a passive state. In an exemplary embodiment, the heater system 10 may be integrated with a vessel 81 in order to warm up its content 89, which is consist of some exemplary embodiments of this disclosure. Having a fresh-brewed coffee or tea anytime, anywhere may be suitable for people who prefer to have a fresh brewed coffee or tea instead of warming up a previously brewed coffee. In an exemplary embodiment, the heater system 10 may be integrated to the vessel 81 by a washer 27, which may seal the product to prevent the content leakage.

In an exemplary embodiment, the vessel 81 may be positioned into a container 82 in order to protect the user's hand to be burnt and may further prevent the possible fumes to be released. In an exemplary embodiment, the fumes may be filtered out by a filter 83 which may be made from an activated carbon or any other possible filters. The exemplary filter may be stuck to the container 82 by a two sided tape 84 or any kind of adhesive materials.

In an exemplary embodiment, the exemplary vessel 81 may have a tea filter strainer 813 which may include a place to be occupied by coffee or tea 814. The diameter of the vessel 81 may be less than previously described products which may cause the content 89 inside the vessel 81 to be boiled after the activation. This may cause the boiled content 89 pass through the tea filter strainer 813 by pressure and brew the coffee or tea 814. In an exemplary embodiment, when the user activates the heater system 10, the content 89 may be boiled and pass through coffee or tea 814 with a high pressure and may get out from the straw 816.

FIG. 8B shows an exemplary embodiments of a sectional side view of a fresh-brewed coffee maker 80 or tea brewer with a mechanical activator in an activated state. In an exemplary embodiment, the user may push or twist the cover 821 and this may move the rod 24 through the hole of the circular surface 22 and punch the metal tape 23 to activate the product. In an exemplary embodiment, the fresh-brewed coffee maker 80 may be two layers in order to prevent content heat loss and provide an extra space to keep the produced fumes. In an exemplary embodiment, a cup 85 may be positioned on the top of the product to be used as a glass to spill the content 89 into it to be drunk by the user. In an exemplary embodiment, the heater system 10 may boil the content 89 and brew coffee or tea 814 by the pressure of the boiled content 89 in the tea filter strainer 813 and path through the straw 816 to be poured into the cup 85.

FIG. 8C shows an exemplary embodiments of a sectional side view of a fresh-brewed coffee maker 80 or tea brewer with an electrical activator. In an exemplary embodiment, the user may push the button 212 or twist the cover 62 to connect the battery 211 with the soldering iron 26 as same as the heater system 10 that was described in FIG. 2F. Other specifications of the fresh-brewed coffee maker 80 or tea brewer with electrical activator are same as the fresh-brewed coffee maker 80 with mechanical activator, however, the design of the cover may be different to include the battery 211 and the button 212.

Referring to FIGS. 8A-C, when the heater system 10 boils the content 89, the amount of the content 89 may be decreased by boiling and eventually the heater system 10 may be positioned in a dry position of the vessel 81. This may cause the combustion chamber 12 to be burnt or molt depend on its material and may add a bad taste to the content. In an exemplary embodiment, in order to change the direction of the reaction through the premixed fuel 14 and provide more time for the reaction, a tube 815 may be positioned inside the combustion chamber 12. In an exemplary embodiment, when the user activates the product, the reaction may start and go through the tube 815 and may reach its highest point. During the reaction inside the tube 815, the heat may raise the temperature of the content 89 to reach its boiling point and when the boiling process may be started, the reaction simultaneously may take place out of the tube 815 inside the combustion chamber 12. In an exemplary embodiment, when the content 89 starts boiling, the reaction inside the combustion chamber 12 may simultaneously change its direction to progress from top to down. This may cause to avoid the heater system 10 to be placed in a dry position, which may lead to produce more fumes and increase the risk of molting or burning the combustion chamber 12.

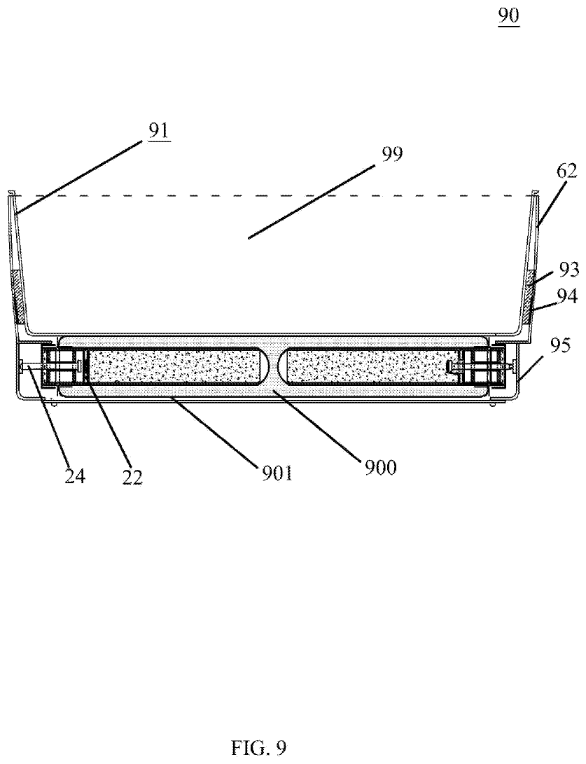

FIG. 9 shows an exemplary embodiments of a sectional side view of a daily dish heater 90 with two heater systems 10 and mechanical activators that one of them are in a passive state and the other one is in an activated state. Having a daily dish heater is very useful for employees, students, or far distant workers who have not enough time or facilities to warm up their daily meals. In an exemplary embodiment, the heater system 10 may warm up an intermediate fluid 900 which may transfer the heat to the content 99 in order to prevent the content 99 to be burnt by the intensive heat of the heater systems 10. In an exemplary embodiment, the heater system 10 and the intermediate fluid 900 which may positioned in a heat transfer tank 901 may be integrated with any kind of dishes 91 in order to warm up its content 99. In an exemplary embodiment, The intermediate fluid 900 may be a fluid with a high boiling point, a low melting point, a high heat transfer coefficient, and a low heat specific heat capacity, In an exemplary embodiment, may be one of or a mixture of . . . or a Phase Change material (PCM). In an exemplary embodiment, the heater system 10 may be integrated to the dish 91 by a washer 27, which may seal the product in order to prevent the content leakage.

In an exemplary embodiment, the daily dish 91 may have a container 92 in order to prevent the user's hand to be burnt and prevent the produced fumes to be released and annoy the user. In an exemplary embodiment, the fumes may be filtered out by a filter 93, which is made from an activated carbon or any other possible filters and is suck to the cover 92 by a two sided tape 94 or any kind of adhesive materials.

In an exemplary embodiment, the exemplary daily dish heater 90 may have two independent heater systems 10 in order to produce more heat for warming up the food. The user may alternatively activate one or both of these heater systems 10 and they can be removed and replaced individually. In an exemplary embodiment, the daily dish heater 90 may be utilized with one or more heater systems 10 and may be alternatively activated by mechanical or electrical activators as it was described before.

In an exemplary embodiment, the user may push or twist the cover 95 and this may move the rod 24 through the hole of the circular surface 22 and punch the metal tape 23 to activate the product. In an exemplary embodiment, the daily dish heater 90 may be two layers in order to prevent the content heat loss and provide an extra space to keep the produced fumes.

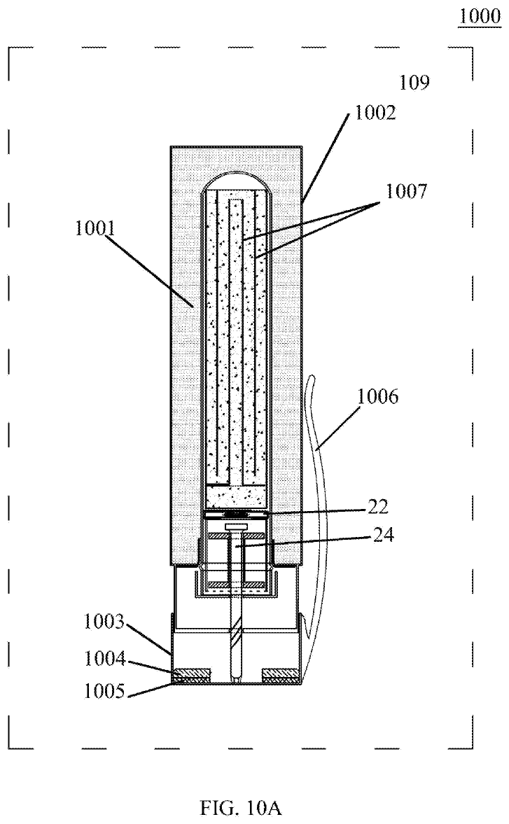

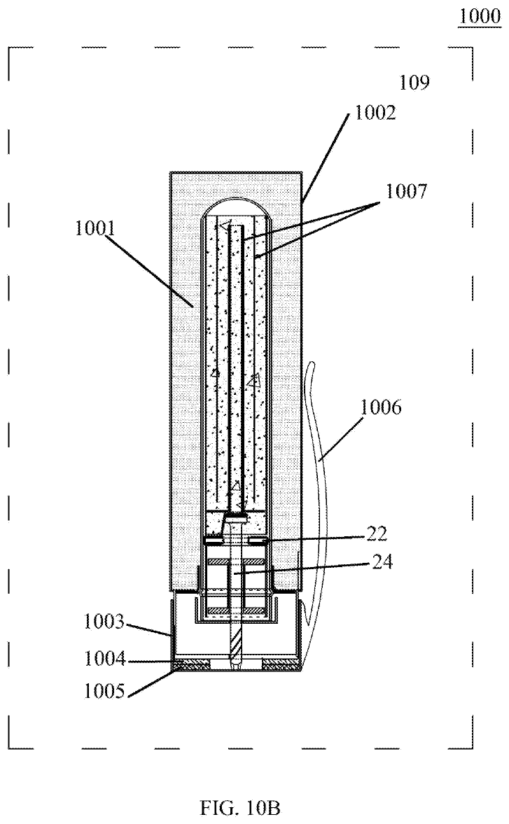

FIG. 10A shows an exemplary embodiments of a sectional side view of a multi-purpose heater 1000 with a mechanical activator in a passive state, which is consist of some exemplary embodiments of this disclosure. In an exemplary embodiment, the heater system 10 may warm up an intermediate fluid 1001, which can transfer the heat to a closed space 109. In an exemplary embodiment, in order to prevent the things in the closed space 99 to be burnt by the intensive heat of the heater systems 10, there is an intermediate fluid 1001 which may be heated by the heater system 19 and it can warm up other things. In an exemplary embodiment, the heater system 10 and the intermediate fluid 1001 which may positioned in a heat transfer tank 1002 may warm up any kinds of closed spaces which may have something that should be warmed up or keep warm for a long time. In an exemplary embodiment, The intermediate fluid 1001 may be a fluid with a high boiling point, a low melting point, a high heat transfer coefficient, and a low heat specific heat capacity, In an exemplary embodiment, may be one of or a mixture of . . . or a Phase Change material (PCM). In an exemplary embodiment, the multi-purpose heater 1000 may be employed to warm up a closed space 109 such as a bag of a food delivery courier or a package of medicines or chemical materials that should be kept warm for a long time or should be warmed up, or a human's clothes which should be kept warm in a cold weather, or any kind of things that should be warmed up or keep warm that comes to mind without getting away from the scope of this invention. In an exemplary embodiment, the heater system 10 may be integrated to the heat transfer tank 1002 by a washer 27, which may seal the product in order to prevent the intermediate fluid 1001 leakage.

In an exemplary embodiment, the multi-purpose heater 1000 may have a cover 1003 in order to prevent the user's hand to be burnt and prevent the produced fumes to be released and annoy the user by the released fumes or their odors. In an exemplary embodiment, the fumes may be filtered out by a filter 1004, which is made from an activated carbon or any other possible filters and is suck to the cover 1003 by a two sided tape 1005 or any kind of adhesive materials.

In an exemplary embodiment, the exemplary multi-purpose heater 1000 may further have a handle 1006 on its lid 1003, to simply be attached to anything else. In an exemplary embodiment, the handle 1006 is flexible and can be attached for example to a paper package of foods which restaurants put their foods inside it to give them to a food delivery courier. In an exemplary embodiment, the exemplary multi-purpose heater 1000 may be put inside a packaging which may put inside a food delivery packaging and can be either a single-use or multi-use product. In an exemplary embodiment, a single-use multi-purpose heater 1000 may be positioned in the paper packaging of foods by restaurants and may be carried out inside a food delivery bag by a courier and after usage may be come back through the deposit system by the customers of a food delivery company. In an exemplary embodiment, a multi-use multi-purpose heater 1000 may be provided by a food delivery company and may be put inside the food delivery bag in order to warm up all the foods inside a food delivery bag and may be removed and replaced by the courier and may be come back through a deposit system by the courier. The material and manufacturing quality may be different depend on being single-use or multi-use product and the activation mechanism can be either mechanical or electrical.

FIG. 10B shows an exemplary embodiments of a sectional side view of the multi-purpose heater 1000 with a mechanical activator in an activated state. In an exemplary embodiment, the user may push or twist the cover 1003 and this may move the rod 24 through the hole of the circular surface 22 and punch the metal tape 23 to activate the product. In an exemplary embodiment, the cover 1003 may be able to prevent the user's hand to be burnt and provide an extra space to keep the produced fumes.

In an exemplary embodiment, in order to extend the reaction time which may cause to keep warm the foods inside the delivery bag for a longer period of time, and provide more time for the reaction to be taken place, a pairs of tubes 1007 may be positioned inside the combustion chamber 12 through the premixed fuel 14. In an exemplary embodiment, when the user activates the product, the reaction may start and go through the tube 1007 and may reach its highest point then the reaction may go through the second layer of tubes 1007 and after that may be go forward between the second layer of tubes 1007 and the combustion chamber 12. This may extend the reaction time and depends on the required reaction time the material of premixed fuel 14 and the number of layers of tube 1007 inside the combustion chamber 12 may be altered to increase or decrease the reaction time.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

Throughout this specification and the claims which follow, unless the context requires otherwise, the word “comprise”, and variations such as “comprises” or “comprising understood to imply the inclusion of a stated integer or step or group of integers or steps but not to the exclusion of any other integer or step or group of integers or steps.

What is claimed is:

1. A heater system, comprising:
a combustion chamber which is a metal closed or semi-closed chamber comprising;
A thermal battery embedded in the combustion chamber comprising:
a thin metal mesh to sustain the structure of the thermal battery;
a thin metal foil disposed within the metal mesh;
a premixed fuel disposed within the metal foil to produce heat when it is activated,
the premixed fuel comprising:
a group of oxidizer materials comprising at least one of or a combination or mixture of calcium permanganate, sodium permanganate, potassium permanganate, silver permanganate, sodium manganate, and potassium manganite;
a group of oxidizable materials comprising a combination, mixture or an alloy or at least one of lithium, sodium, magnesium, aluminum, manganese, and Iron;
a group of materials which control the heat producing rate comprising at least one of FeO, MnO2, and Al2O3;
a group of materials which control the heat consuming rate comprising at least one of or a combination of ferric oxide, manganese dioxide, aluminum oxide, zinc oxide, magnesium oxide, and copper oxide;
an activator to activate the thermal battery. The activator comprising:
a chemical starter to start a spontaneous reaction among the premixed fuel comprising:
a circular surface with a central hole;
a membrane stuck on the central hole of the circular surface;
a rectangular ribbon on the central hole of the circular surface to guides the membrane to be punctured in a rectangular shape;
a group of chemical starter materials embedded in the central hole of the circular surface and covered with the membrane comprising at least one of:
a combination or mixture or at least one of propylene glycol, hydrogen peroxide, sulfuric acid and a cotton or wood pulp made fibre, or;
a combination or mixture or at least one of phosphorous, cellulose, a cotton or wood pulp made fibre, sulfur, magnesium, and aluminum;
an initiator to actuate the chemical starter comprising at least one of:
a mechanical initiator comprising;
a rod to puncture the membrane of chemical starter by movement;
a holder to hold the rod in the right position and direction to be moved precisely through the hole of the circular surface;
an electrical initiator comprising;
a soldering iron to burn the chemical starter by heating;
a battery or a number of batteries to provide the power of the soldering iron;
a button to connect the soldering iron and the battery;
a lid to close the combustion chamber comprising a hole to pass out fumes, the rod, or the soldering iron;
wherein, the user switches the heater system from a passive state t to an active state by at least one of:
moving the rod passed through the lid and held by the holder toward the central hole of the circular surface to puncture the membrane in the shape of the rectangular ribbon to get the group of chemical starter materials into contact with the premixed fuel and start a spontaneous reaction through the premixed fuel.
pushing the button to connect the battery to the soldering iron to heat and burn the chemical starter through the premixed fuel and start a spontaneous reaction through the premixed fuel.

2. The heater system of claim 1, wherein the thermal battery is removably disposed within the combustion chamber and can easily be placed within or removed from the combustion chamber. The thermal battery can be placed individually and separate from the heater system in a package to be carried out.

3. The heater system of claim 1, wherein the group of oxidizer materials comprises a combination or mixture or at least one of 5 to 15 wt. % calcium permanganate, 15 to 35 wt. % sodium permanganate, 25 to 65 wt. % potassium permanganate, 1 to 5 wt. % silver permanganate, 5 to 25 wt. % sodium manganate, and 10 to 35 wt. % of potassium manganate, based on the total weight of the premixed fuel.

4. The heater system of claim 1, wherein the group of oxidizable materials comprises a combination, mixture or an alloy or at least one of 0.01 to 0.1 wt. % of lithium, 0.05 to 0.2 wt. % sodium, 0.1 to 0.4 wt. % of magnesium, 10 to 25 wt. % of aluminum, 7 to 14 wt. % of manganese, and 20 to 45 wt. % of iron based on the total weight of the premixed fuel.

5. The heater system of claim 1, wherein the group of materials which control the heat producing rate comprises a combination or mixture or at least one of 2 to 10 wt. % of FeO, 5 to 12 wt. % of MnO2, and 10 to 35 wt. % of Al2O3 based on the whole weight of the premixed fuel.

6. The heater system of claim 1, wherein the group of materials which control the heat consuming rate comprises a combination or mixture or at least one of 5 to 15 wt. % calcium permanganate, 15 to 35 wt. % sodium permanganate, 25 to 65 wt. % potassium permanganate, 1 to 5 wt. % silver permanganate, 5 to 25 wt. % sodium manganate, and 10 to 35 wt. % of potassium manganate based on the total weight of the premixed fuel.

7. The heater system of claim 1, wherein the group of chemical starter materials comprises a combination or mixture or at least one of propylene glycol, hydrogen peroxide, acid sulfuric, phosphorous, sulfur, magnesium, aluminum, cellulose, and a cotton or wood pulp made fibre.

8. The heater system of claim 1, wherein the activator comprises a circular surface with a central hole to encompass the group of chemical starter materials and covered with the membrane to be either ruptured by the movement of the rod in the rectangular shape of the ribbon to communicate the chemical starter and the premixed fuel or burnt by a soldering iron powered by a battery to start a spontaneous reaction among the premixed fuel.

9. The heater system of claim 8, wherein the combustion chamber is integrated with a container such as a vessel, can, cup, mug, thermos, or a fresh-brew coffee maker to heat its content and is sealed with a hole on the surface of the container by a washer and can be placed within or removed from the container.

10. The heater system of claim 9, wherein the combustion chamber and the container are placed in a second container to collect the produced fumes of the reaction among the premixed fuel between the container and the second container and can filter out the fumes by a filter.

11. The heater system of claim 10, wherein the activator is coupled with an intermediate member to move the rod through the central hole of the circular surface by either the movement of the intermediate member or twisting the intermediate member comprising a treated surface to convert the twisting to the movement of the rod.

12. The heater system of claim 10, wherein the thermal battery further include an extinguisher system to stop the reaction among the premixed fuel in case of inadvertent activation comprising a wrapped soldering wire between two pairs of funnels in vertical and horizontal symmetrical shape and can be melted by the produced heat of the reaction among the premixed fuel and flows between the pairs of funnels to block a narrowed path among the thermal battery to stop the reaction among the premixed fuel.

13. A thermal battery comprising a premixed fuel enclosed by a metal foil and a metal mesh and can be either placed in a package for transportation or removably placed inside a combustion chamber to be activated by either a mechanical or electrical activator to start a reaction among the premixed fuel.

14. The thermal battery of claim 13, wherein the premixed fuel can heat the combustion chamber sealed with a container comprising a content or an intermediate fluid to avoid overheating the content.

15. A self-heating product comprising:
a first container to contain a content with a hole on one of its surface. The content comprising at least one of:
a food, beverage, or anything that should be heated, or boiled
an intermediate fluid to heat a food, beverage, or anything that should be heated, or boiled gently to avoid burning them;
a heater system comprising:
a combustion chamber with a semi-closed chamber;
a thermal battery placed removably in the combustion chamber. The thermal battery comprising at least one of:
a premixed fuel;
a metal foil surrounded the premixed fuel;
a metal mesh surrounded the metal foil to sustain it;
an extinguisher system comprising a soldering wire wrapped between two symmetrical pairs of funnels to be melted and stop the reaction in case of overheating;
a number of pipes embedded in the premixed fuel to prolong the reaction path and extend the reaction time;
a chemical starter comprising:
a circular surface with a central hole a group of chemical starter materials occupied in the central hole of the circular surface
a membrane covered the hole of the circular surface;
a rectangular ribbon to guide the membrane to be ruptured in a rectangular shape;
an initiator comprising at least one of:
a rod to rupture the membrane by the movement toward the central hole of the circular surface to communicate the group of chemical starter and the premixed fuel to start a reaction among the premixed fuel;
a soldering iron powered by a battery to born the chemical starter when switches on by clicking a button to start a reaction among the premixed fuel;
a lid of the combustion chamber with a central hole to pass either the rod or the soldering iron to be available;
a washer placed in the hole of the container to seal the combustion chamber;
an intermediate member to facilitate the movement of the rod through the lid by a movement or rotation;
a second container surrounded the first container and the combustion chamber to collect the produced fume of the reaction among the premixed fuel;
a filter stuck between the container and the second container to filter out the produced fume of the reaction among the premixed fuel;
an optional third container placed on the top of the first container to spill the heated content inside it to facilitate eating or drinking it;
an optional opener mechanism attached to the third container to open the lid of the first container by moving the third container;
an optional thermometer to show the inside temperature from the outside of the Self-heating product.

17. The self-heating product of claim 16, wherein the product further include a tea filter strainer to be occupied by coffee, tea, herbal tea, etc. and can brew them by passing the heated or boiled content through the tea filter strainer.

18. The self-heating product of claim 16, wherein the product has two or more piece of the combustion chamber to heat a food.

19. a self-heating product to heat a bag of a food delivery courier comprising at least one of:
a heater system attached to a package of food and can be placed inside the bag of food delivery bag to keep the it warm during the delivery of the food;
a heater system embedded in the bag of food delivery carrier to keep the bag warm in a predetermined period of time during the food delivery courier working time.

20. A self-heating product that can be recycled and recharged after using by melting its premixed fuel by solar energy.
